(19) United States
(12) Patent Application Publication
(10) Pub. No.: US 2013/0268114 A1
(43) Pub. Date: Oct. 10, 2013

(54) System and Method for Vibration Transport

(71) Applicants: Alfred Rasmussen, Svendborg (DK); Jan Østergaard Knudsen, Sunds (DK)

(72) Inventors: Alfred Rasmussen, Svendborg (DK); Jan Østergaard Knudsen, Sunds (DK)

(73) Assignee: Alvibra A/S, Svendborg (DK)

(21) Appl. No.: 13/885,028

(22) PCT Filed: Nov. 11, 2011
(86) PCT No.: PCT/DK2011/050428

§ 371 Date: Jun. 24, 2013

(30) Foreign Application Priority Data
Nov. 11, 2010 (DK) 2010 70480
Apr. 8, 2011 (PA) 2011 70166

(51) Int. Cl. B65G 27/00; B65G 43/08

(52) U.S. Cl. CPC B65G 27/00; B65G 43/08
USPC 700/230

(57) ABSTRACT

A transport system and method has a support frame which carries at least a first reciprocating conveyor and a second reciprocating reference mass. The reciprocating conveyor and reference mass are connected by springs. The system has at least one first force generating apparatus and at least one activation spring connected to the force generating apparatus. The activation spring is connected to at least one reciprocating conveyor or the reciprocating reference mass. The system and method for vibration transport of goods determines the mass of goods delivered by the transport system. The support frame is carried by at least one load cell. The load cell is connected to a computer system. The computer system performs a calculation of the mass of transported goods. The computer system delivers a continuous measurement of the mass of the goods which are transported.

### FIELD OF THE INVENTION

The present invention relates to a transport and weighing system comprising at least a first reciprocating tube or trough or other conveying means and a second reciprocating reference mass, which first or second reciprocating tube or trough or other conveying means are forced to oscillate in a mostly reciprocal movement by one ore more actuators, such as disclosed in EP 1349676 B1, filed by the same applicant.

The present invention further relates to a method for transport of goods by a vibrating transport system, which transport system comprises reciprocating movable conveying means and a reciprocating reference mass interconnected by spring means, which reciprocating conveying means and reciprocating reference mass are connected to a force generating apparatus, where goods in form of grains are loaded in the reciprocating conveying means, and the force generating apparatus is started, and the reciprocating conveying means and the load of grains starts to reciprocate within the conveying means.

### BACKGROUND OF THE INVENTION

U.S. Pat. No. 4,428,476 and U.S. Pat. No. 5,056,652 disclose a vibratory conveyor arranged so that the vibrations have a substantially greater horizontal than vertical movement. More particularly, the vertical acceleration of material carried by the conveyor is less than the acceleration of gravity and therefore the material conveyed does not physically leave the surface of the conveyor. The result is a smooth flow of material from one end of the trough to the other.

U.S. Pat. No. 5,836,204 concerns balanced vibration generator for resonance-amplified operation of a machine or equipment comprising at least one set of counter-oscillating masses, suspended in a spring system in which the resonance springs are helical springs which also support the masses. The generator comprises a built-in, balanced drive system. The generator is suspended in securing elements which comprise special, adjustable securing elements which are in engagement with the resonance springs and arranged in such a manner that the resonance springs, when turned around their longitudinal axes, can change spring lengths.

U.S. Pat. No. 6,705,459 concerns a vibratory feeder, which is minimized in an assembly including a base and an elongated, generally horizontal, feeder spaced from the base. A rotating mounted eccentric is placed on the feeder and is operable, when rotated, to impart vibration to the feeding surface of the feeder. The feeder is interconnected to the base by an interconnection that consists essentially of springs having first ends connected to the feeder and opposite ends connected to the base while being located on a generally horizontal axis.

JP 9005148 discloses a method and apparatus for supplying a specified amount of powder body within a specified accuracy in specified time length. The apparatus comprises a first vibration feeder having a base plate allowed to be vibrated and a second vibration feeder having a base plate which is placed on a weighing device and allowed to be vibrated. A powder body is fed unto the base plate with an overall bulk density being averaged and the powder body is delivered to a base plate from the base plate so that a part of the bulk density is concentrated partially while the quantity of the powder body is weighed with the base plate at rest. The amount of the powder body to be supplied to a container from the base plate is charged hourly.

### OBJECT OF THE INVENTION

It is the object of the pending application to describe a system and a method for vibration transport of goods and to determine the mass of goods delivered by the transport system.

### DESCRIPTION OF THE INVENTION

The object can be fulfilled by a system as described in the preamble to the claim 1 and further modified if the transport system is at least partly or full carried by one or more load cells, which load cells is connected to a computer system, which computer system performs a calculation of the mass of transported goods.

Hereby can be achieved, that the computer system can deliver a continuous measurement of the mass of the goods which are transported. The weight of the goods may be important e.g. in process calculations and for quality control and documentation in process industry. For many purposes, it is very important to deliver the correct defined mass of goods transported in an automatic conveyor system. It is well-known by belt-conveyor transportation systems to calculate the weight of the goods delivered by the belt. By vibration transportation this has previously been impossible because the vibration has negative influence of the result received from load cells. A special computer system is needed to overcome noise in electric signal generated by load cells. The computer system can perform digital filtration of received signals, and as such the computer system can give at least an average measurement over a short period of time. Hereby, a vibration transport system may work just like a standard moving trough which performs combined transport and weighing system. The transport system described in the pending application has an advantage in that the transporting conveying means can be relatively long. Another advantage is that transportation is performed inside a conveying means in the form of a tube instead of a moving trough. The transport system as described in the pending application uses a second reciprocating reference mass. The oscillating system as such comprises both the reciprocating conveying means and the reciprocating reference mass interconnected by springs which forms an oscillating system which is in operation with a resonance frequency. Operating in the resonance frequency area will limit the necessary forces which have to be added to the oscillating system so that relatively weak motors can be used to drive the oscillating system e.g. by an eccentric exciter connected to a motor and to a connection spring. Hereby, it can be achieved that only a low amount of energy is necessary for transporting goods in the reciprocating conveying means.

A feed hopper can comprise a pre-feeder, which can be connected to the inlet to the reciprocating tube or trough, which pre feeder can generate a homogenous flow of material into the reciprocating tube or trough. By using a pre-feeder at the inlet to the reciprocating tube or trough, it can be achieved that a relatively homogenous layer of goods or grain is delivered into the reciprocating tube or trough. By letting the pre-feeder comprise a vibrating cone near its outlet, it is possible that the material will be prevented from sticking in the pre-feeder. Preferably the pre-feeder is carried by itself so that the pre-feeder is mechanically independent of the reciprocating tube or trough.

The vertical level of goods or grain can be measured by at least one optical distance measurement system. By measuring the vertical level of the material in the form of grain or goods conveyed in the reciprocating tube or trough, it is possible to indicate the actual volume that is being conveyed. Hereby overfilling of the reciprocating tube or trough can be prevented. By using feedback routine from the measurement of the vertical level it is possible, by the control of the pre-feeder to achieve a very homogenous layer of material in the reciprocating tube or trough.

At least a first accelerometer can be connected to the reciprocating tube or trough. By measuring the actual acceleration existing in the reciprocating tube or trough, it is possible to together with know-how about the material conveyed and the vertical level measurement to measure the mass flowing through the reciprocating tube or trough. Hereby it can be achieved that the very precise mass flow can be delivered at an outlet, because the pre-feeder can be adjusted for controlling the mass flow.

The actuator can be formed as one or more linear actuators which number of actuators can increase with longer transport systems, which linear actuators are connected to the first reciprocating tube or trough and to the second reciprocating reference mass. The reciprocating movement of the tube or trough and the counter movement of the reference mass can be achieved in various ways. One possibility is to use a rotating electric motor and by use of a crankshaft mechanism to achieve the reciprocation. In an alternative embodiment of the invention, linear actuators could be connected between the reference mass and the tube or trough so that the actual vibration is generated exactly in the correct direction by for example four linear actuators. These linear actuators could be electric, may be formed as magnetic plungers. By alternative embodiments it is also possible to use hydraulic or pneumatic actuators for achieving the reciprocating movement.

The outlet of the reciprocating tube or trough can deliver transported material into a weighing bucket. By connecting a weighing bucket to the outlet of the reciprocating tube or trough, it is possible to perform an automatic control of the amount of material being conveyed. The weighing bucket can be used for a daily calibration or it can be coupled continuously in order to obtain a very precise indication of the mass of the material conveyed.

The actuators can be controlled by a computer system, which computer system receives information from at least the weighing cells and from the accelerometer, which computer system can calculate the weight of the transported material. The computer system can be used for controlling the actuators and controlling the pre-feeder and also receiving feedback from the weighing bucket. Probably, input will also come from the optical level of detection, so that the computer system, based on data from accelerometer and the optical vertical measurement can calculate the mass flow to the vibrating tube or trough. Depending on the material being conveyed, it is possible to change both the frequency of the vibration and may be also change the vibrating amplitude. In most situations, the vibration frequency is to be very close to the natural oscillating frequency of the mechanical system of the tube or trough and the counter oscillating reference mass. Therefore the influence of the oscillating frequency is rather limited, but depending on the mass or material being conveyed it can be necessary to slightly change the frequency. By using the computer system, it is possible to perform a control of a system so that the system can operate fully automatically.

The second reference mass can be formed as one or more second conveying means, which first and second conveying means are forced into opposite reciprocating. Hereby can the first and second conveying means form two parallel operating transport units. In an alternative embodiment can two conveying means operate serial and thereby forming a very long conveying unit.

The first and second reciprocating conveying means or reference mass can be connected by spring means. Herby can the first and second reciprocating conveying means or reference mass form a resonance oscillating system.

The transport system can be carried by a support frame. Hereby can be achieved that the support frame can receive and reduce oscillation generated by the reciprocating conveying means or reference mass. This can lead to an effective reduction of vibrations transmitted to the weight cell.

The support frame is carried in at least one hanger, which hanger carries the support frame by at least one flexible band. Hereby it can be achieved that only small vibrations will be transmitted to the floor below the transport system. At first only small vibrations are transmitted to the support frame, and when the support frame is hanging in e.g. flexible bands in the hanger, only very limited vibrations are to be delivered towards the floor.

The hanger is carried by at least one load cell. By placing load cells under the hanger, it is possible to measure the weight of goods filled into the reciprocating conveying means. Measuring the weight at least one point where vibrations are reduced gives a more accurate measurement. Therefore, the necessary filtration in a digital filter in a computer system can be reduced. If more hangers are necessary for supporting e.g. the long reciprocating conveying means and the reciprocating conveying means reference mass, it is possible to place the load cells under each of the hangers so that the computer system will receive a number of load cell information when the system is in operation. Hereby, it can be indicated approximately where in the conveying means the concentration of goods is the highest and where it is the lowest. If e.g. a conveying means is full, there is no reason for adding more goods into the conveying means.

The spring means can comprise a first and a second row of springs, which rows of springs are placed at the side and fastened to the side of both the reciprocating conveying means and the reciprocating reference mass. By placing the springs by the side of the reciprocating conveying means and by the side of the reciprocating reference mass, the springs are out of the way allowing both the conveying means and the reference mass to be placed relatively close to each other. In that way, a relatively low transportation apparatus can be performed. By placing the springs at both sides of the reciprocating conveying means and the reciprocating reference mass, the oscillation can be more or less controlled by the springs themselves. Consequently, no further guiding means are necessary to keep the oscillating components in place.

The spring means can be supported by flexible spring supports, which spring supports are fixed to the support frame. The reciprocating conveying means and the reciprocating reference mass need to be supported in order to have freedom of movement when the system is in operation. Therefore, support is placed at the reference frame where the springs are supported at both ends. Thereby, both the reciprocating conveying means and the reciprocating reference mass are carried by flexible means allowing for reciprocating movement with only little friction.

The reciprocating conveying means and the reciprocating reference mass can be reciprocating in both horizontal and vertical direction, which horizontal reciprocation is larger than the vertical reciprocation. By letting the reciprocation take place in a slightly upward direction, it is possible by the reciprocation to let the goods more or less be lifted upwards in a period when the conveying means is moved backwards. But in order to have an upward acceleration, the reciprocation must take place with a degree of approximately 30 degrees above the horizontal line. In that way sufficient energy is delivered to the particles of the goods so they may not be flying in the conveying means, but they are losing most of their weight when the conveying means moves backwards, and as such the grain of goods are moved forwards. The bigger the horizontal movement, the faster the transportation will be performed. Therefore, the angle of the reciprocation could be adjusted independently of the weight of the grains of the goods which are transported.

The object can also be fulfilled by a method as described in the preamble to claim 7 and further modified if the method performs measuring the load of the goods transported in the reciprocating movable conveying means by at one or more load cells, transmit measured values to a computer system, where the computer system calculates the amount of goods transported in the conveying means.

By the method, a highly efficient transport system can be achieved which is not only able to transport the goods but also to measure the weight of the goods which are delivered. Hereby, a vibration transportation system can perform the same job as a transport trough. But the advantage is that transportation takes place in a closed conveying means instead of on an open trough. The reciprocating conveying means and the reciprocating reference mass can be very long; so long transportation can be performed in a closed conveying means. The length of the transport system only depends on the number of support springs necessary for carrying the reciprocating conveying means and the reciprocating reference mass. Systems longer than 10 metres would be possible.

### DESCRIPTION OF THE DRAWINGS

FIG. 1 shows a side view of a vibrating system

FIG. 2 shows a top view of the same vibration unit

FIG. 3 shows a sectional view of the back of the same system.

FIG. 4 shows a side view of a possible embodiment of a hanger.

FIG. 5 shows the top view of the same hanger as indicated at FIG. 4.

FIG. 6 shows a side view of the same embodiment as shown at FIGS. 4 and 5.

FIG. 7 shows a side view of a possible embodiment of a frame.

FIG. 8 shows the same frame as FIG. 7, but seen from the top.

FIG. 9 shows an alternative possible embodiment 102 for a conveyor system.

FIG. 10 shows a top view of the same embodiment as the FIG. 9.

FIG. 11 shows a possible embodiment for a linear actuator.

FIG. 12 shows an alterative embodiment for the invention seen for one side.

FIG. 13 shows the same embodiment as FIG. 12 but seen from the top.

### DETAILED DESCRIPTION OF THE INVENTION

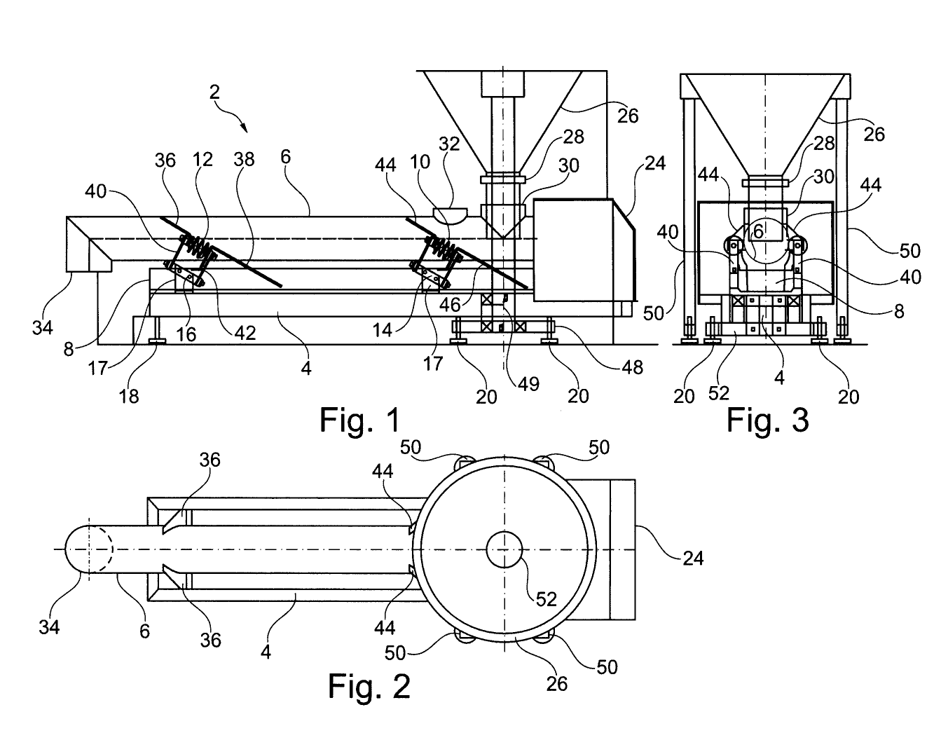

FIG. 1 shows a system 2 which comprises a frame 4 which carries the system 2. The system comprises the reciprocating conveying means 6 in form of a tube or a trough and the reciprocating reference mass 8 which reciprocating conveying means 6 and reciprocating reference mass 8 are connected by springs 10, 12. The springs are carried by support means 14, 16. The frame 4 is carried at load cells 18, 20. A housing 24 covers the not shown motor, the eccentric and the activation springs. A feed hopper 26 is indicated which is connected to flexible connection means and further into a connection 30 into the reciprocating tube or trough 6. The reciprocating tube or trough 6 further comprises an outlet opening 34 where goods are delivered. The spring 12 is fastened to the conveying tube or trough 6 by a connection 36 and the spring 12 is further connected to the reciprocating reference mass 8 by a connection 38. Further, the spring 10 is connected to the reciprocating tube or trough 6 by connection 44 and by connection 46; there is a connection of the spring 10 towards to the reciprocating reference mass. The springs 10, 12 are carried by flexible supports 40, 42. A frame 48 is supported by the load cells 20. This frame 48 supports a hanger which is described later.

FIG. 2 shows the same embodiment as FIG. 1 but seen from above. Therefore, FIG. 2 shows the system 2 which comprises the support frame 4 and also the reciprocating tube or trough 6. The outlet opening 34 of the reciprocating tube or trough 6 is indicated. Further, the connection 36 is indicated which connects the reciprocating tube or trough 6 with the spring 12, and furthermore, the connection 44 is indicated which is connected to the spring 10. Besides the feed hopper 26, legs 50 are indicated which are carrying the feed hopper 26. Further, the housing 24 is indicated. Inside the feed hopper 26 is indicated an opening 52.

FIG. 3 shows a sectional view of the housing 24 where the opening to the conveying means 6 is indicated as well as the reciprocating reference mass 8 which is seen from the end. Furthermore, different components of the frame 4 are indicated. The feed hopper 26 and the valve 28 are indicated as well as the connection 30. The feed hopper 26 is carried by the legs 50, and the conveying means 6 is connected to the reciprocating reference mass 8 by flexible connections 40, 42.

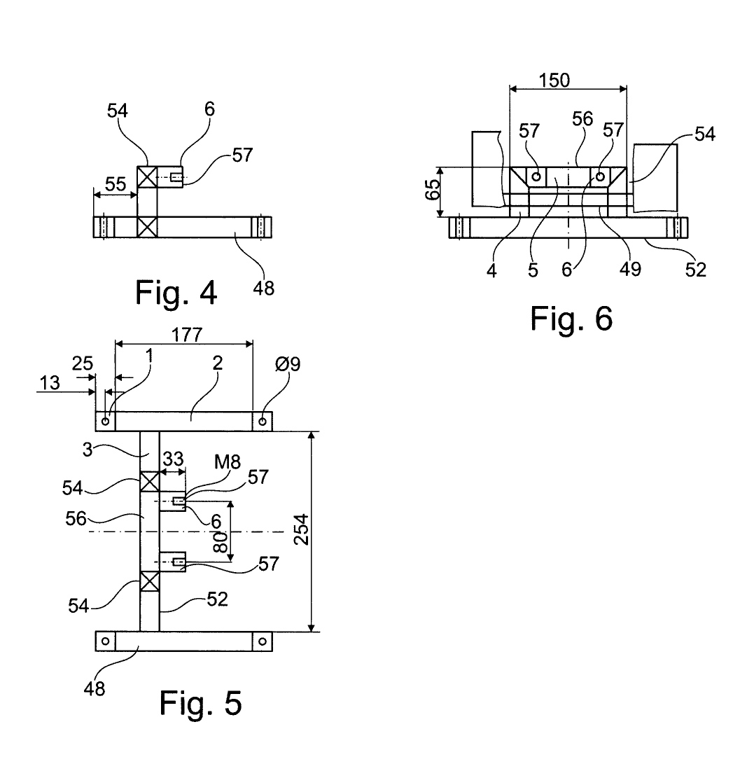

FIG. 4 shows a side view of a hanger which comprises a floor section 48,52 and an upstanding section 54. At the upstanding section 54 is indicated connection means 57.

FIG. 5 shows a top view of the same embodiment for the hanger shown at the FIG. 4. Here is indicated the floor section 48 which two floor sections 48 are interconnected by a connection 52. Vertical sections 54 are indicated and over them is placed a bridge 56. At this bridge 56 are placed connection means 57.

At FIG. 6 there is a side view of the same embodiment as shown at FIGS. 4 and 5 with the vertical section 54 carried at the floor section 52 and the bridge 56. The bridge 56 comprises connection means 57 which are connected to straps 49.

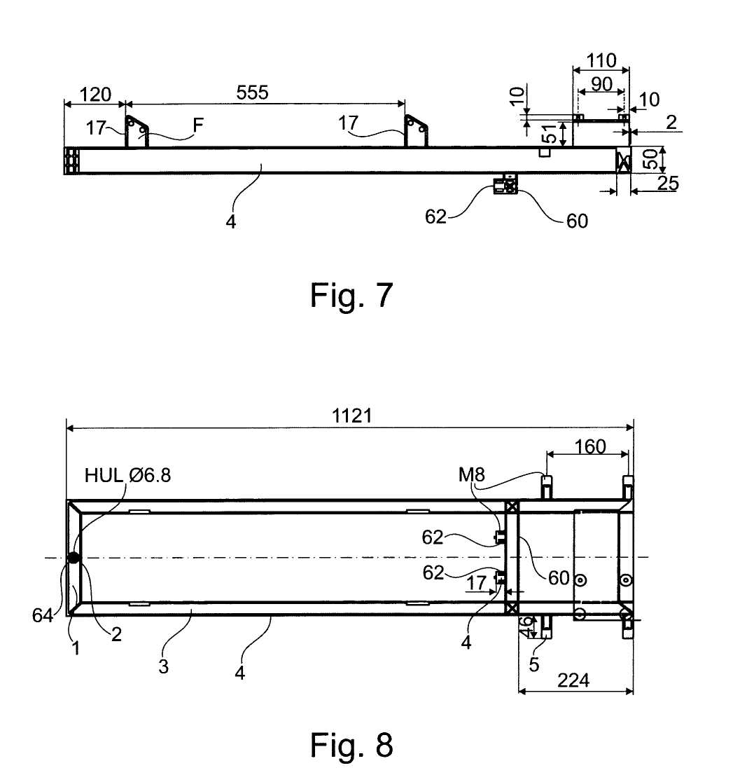

FIG. 7 shows a side view of a frame 4. This frame 4 comprises connection means 17 which are also seen at FIG. 1, and below the frame 4 is indicated a flange 60 and connection means 62.

FIG. 8 shows the frame 4 seen from the top. Here is indicated that the flange 60 is formed as a bridge to which bridge there are indicated connection means 62. At the front of the frame 4 is indicated a connection in a hole 64 for a weigh cell.

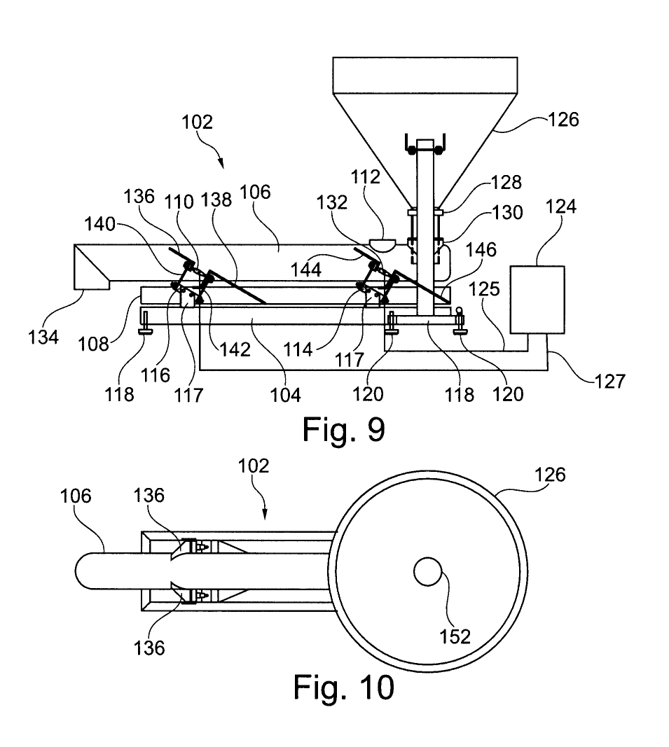

FIG. 9 shows a system 102 which comprises a frame 104 which carries the system 2. The system comprises a reciprocating conveying means 106 in form of a tube or a trough and the reciprocating reference mass 108 which reciprocating conveying means 106 and reciprocating reference mass 108 are connected by linear actuators 110 and 112. The linear actuators 110 and 112 are carried by support means 114, 116. The frame 104 is carried at load cells 118 and 120. A computer system 124 is through power and communication lines 125, 127 connected to the actuators 110 and 112. A feed hopper 126 is indicated which is connected to a flexible connection means 128 and further into a connection 130 into the reciprocating tube or trough 106. The reciprocating tube or trough 106 further comprises an outlet opening 134 where goods are delivered. The linear actuator 112 is fastened to the conveying tube or trough 106 by a connection 136 and the linear actuator 112 is further connected to the reciprocating reference mass 108 by a connection 138. Further is the actuator 110 connected to the reciprocating tube or trough 106 by connection 114 and by connection 146. There is a connection of the linear actuator 10 towards the reciprocating reference mass 108. The actuators 110 and 112 are carried by flexible supports 140 and 142. A frame 148 is supported by load cells 120. This frame 148 supports a hanger which is described later.

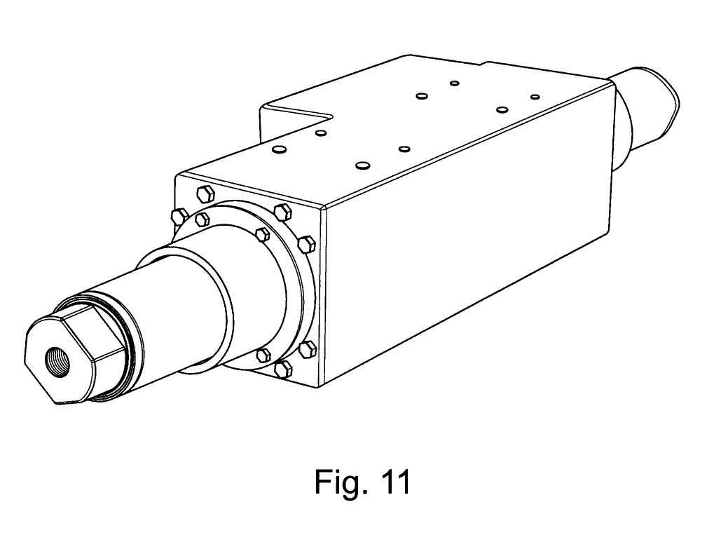

FIG. 10 shows the same embodiment as FIG. 9, but seen from above. Therefore, FIG. 10 shows the system 102 which comprises the support frame 104 and also the reciprocating tube or trough 106. Further the connection 136 is indicated which connects the reciprocating tube or trough 106 with the linear actuator 112.

FIG. 11 shows a possible embodiment for one of the linear actuators 110 and 112. The actuator is a so-called ServoTube Hygienic Actuator which is produced out of stainless steel and which is especially to be used for hygienic purposes. Further information about this actuator could be found at www.copleycontrols.com

In operation the oscillating forces are generated by the linear actuators 110 and 112 for starting an oscillation between the tube or trough 106 and the reference mass 108. These linear actuators are controlled by the computer system 124 which by communication lines 125 and 127 is communicating with the linear actuators 110 and 112. Since the actuators 110 and 112 have a feedback system the actual position will always be available in the computer. Therefore, a very precise mostly sinus formed oscillation could be achieved. Both the frequency and the amplitude of the oscillation can be controlled by the computer system. The computer system therefore knows the actual acceleration that is applied to the oscillating tube 106 and therefore together with information from weighing cells 118 and 120, it is possible to calculate the mass flow through the tube or trough 106.

By the invention as described in the figures described above, it is possible by this vibration transport system not only to transport goods, but also to perform continuous weighing of the goods that are delivered. Weighing cells could be placed in different ways below the frame, and in fact the frame could be developed in a way where only a single weighing cell is able to perform the complete weighing of the product which is delivered. Therefore the pending application is not limited to any described placement of the weighing cells.

Carrying the vibration transport system at the centre for gravity forces acting at the vibration transport system will increase the accuracy of a measuring weigh cell placed at the opposite end of the vibration transport system because only the weight of the transported goods are to be measured at the weight cell.

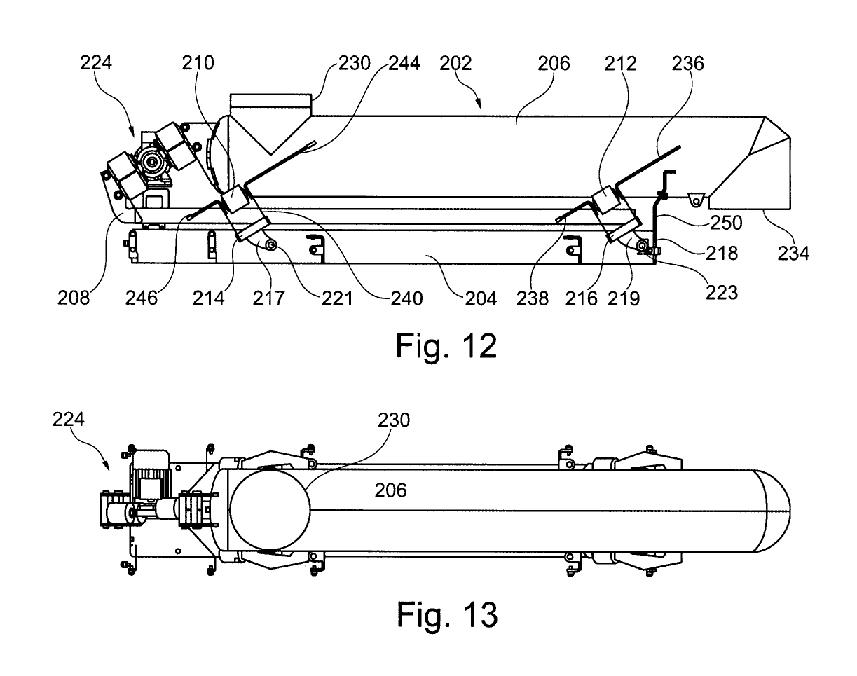

FIG. 12 shows a system 202 which system comprises a support 204 which carries the reciprocating conveying means 206. The tube 206 can be a closed tube in any shape or it could be an open through which could have different kinds of inner surfaces. Depending on the material that has to be transported, the downwards surface inside the tube 206 has to be sufficiently large in order to carry the material. The tube 206 reciprocates in relation to a reference reciprocating mass 208 placed just below the reciprocating tube 206. The reciprocating tube 206 and the reciprocating reference mass 208 are connected by springs 210 and 212. The springs 210 and 212 are supported by flexible springs 240 to fixtures 214 and 216. The fixtures 214 and 216 are part of flange 217 and 219. The flange 217 is free to rotate, but fixed by a bolt 221 to the support 204. The flange 219 is also fixed, but free to rotate by a bolt 223, but to a load cell 218. The reciprocating tube and the reciprocating reference mass 208 are also both connected to an oscillating actuator 224. The tube 206 has an inlet 230 and an outlet 234. The support 204 is also connected to the reciprocating tube 206 by a spring 250 which spring accepts the oscillation of the tube, but supports the tube 206 in order to control the amplitude and also partly the direction of the oscillation.

FIG. 13 shows the same embodiment as the FIG. 12, but especially at FIG. 13 is the actuator 224 seen in a top view. Here is indicated an electric motor which drives the reciprocating tube 208 and the reciprocating reference mass 208.

By the system shown at FIG. 12 or at FIG. 13 can be achieved an oscillating system where nearly 100% of the oscillation remains inside the system and relatively weak oscillation occurs to the surroundings. By a system where nearly 100% of the oscillation remains inside the system, a system with very low energy consumption can be achieved.

1. A transport system comprising at least a first reciprocating tube or trough (6) or other conveying means and a second reciprocating reference mass (8), which first (6) or second reciprocating tube or trough (8)) or other conveying means are forced to oscillate in a mostly reciprocal movement by one or more actuators, wherein the transport system is carried partly or in full by one or more load cells (18,20), which load cell (18,20) is connected to a computer system, which computer system perform a calculation of the mass of transported goods.

2. A transport system according to claim 1, wherein a feed hopper (26) comprises a pre-feeder, which pre-feeder is connected to the inlet to the reciprocating tube or trough, which pre-feeder generates a homogenous flow of material into the reciprocating tube or trough (6).

3. A transport system according to claim 1, wherein the vertical level of goods or grain is measured by at least one optical distance measurement system.

4. A transport system according to claim 1, wherein at least a first accelerometer is connected to the reciprocating tube or trough.

5. A transport system according to claim 1, wherein the reciprocating conveying and the reciprocating reference mass are connected with actuators which is formed as one or more linear actuators

6. A transport system according to claim 1, wherein the outlet of the reciprocating tube or trough delivers transported material into a weighing bucket.

7. A transport system according to claim 1, wherein the actuators are controlled by a computer system, which computer system receives information from at least the weighing cells and from the accelerometer, which computer system calculates the weight of the transported material.

8. A transport system according to claim 1, wherein the second reference mass (8) forms a second conveying means, which first and second conveying means are forced into opposite reciprocating movement.

9. A transport system according to claim 1, wherein the first and second reciprocating conveying means (6) or reference mass (8) are connected by spring means (10,12).

10. A transport system according to claim 1, wherein the transport system is carried by a support frame (4).

11. A transport system according to claim 10, wherein support frame (4) is carried in at least one hanger (54), which hanger (54) carries the support frame (4) by at least one flexible band.

12. A transport system according to claim 11, wherein the hanger (54) is carried by at least one load cell (18,20).

13. A transport system according to claim 12, wherein the said spring means (10,12) comprises a first (10) and a second row (12) of springs, which rows of springs are placed at the side and fastened to the side of both the reciprocating conveying means (6) and the reciprocating reference mass (8).

14. A transport system according to claim 13, wherein the said spring means (10,12) are supported by a flexible spring support (40,42), which spring support (40,42) are fixed to the support frame (4).

15. A transport system according to claim 1, wherein the reciprocating conveying means (6) and the reciprocating reference mass (8) or the second conveying means are reciprocating in both horizontal and vertical direction, which horizontal reciprocation is larger than the vertical reciprocation.

16. Method for transport of goods by a vibrating transport system (2), which transport system (2) comprises reciprocating movable conveying means (6) and a reciprocating reference mass (8), which reciprocating conveying means (6) and reciprocating reference mass (8) are connected to a force generating apparatus, where goods in form of grains are loaded in the reciprocating tube (6), and the force generating apparatus is started, and the reciprocating conveying means (6) and the load of grains starts to reciprocate within the conveying means (6), that the method perform measuring the load of the goods transported in the reciprocating movable conveying means (6) by at least one load cell (18,20), transmit measured values to a computer system, where the computer system calculates the amount of goods transported in the tube.
